(19) United States
(12) Patent Application Publication
(10) Pub. No.: US 2009/0196133 A1
(43) Pub. Date: Aug. 6, 2009

(54) SIGNAL PROCESSING APPARATUS FOR OPTICAL DISC AND METHOD THEREOF

(76) Inventors: Chia-Wei Liang, Taipei County (TW); Yu-Shu Chien, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/345,667

(22) Filed: Dec. 30, 2008

Related U.S. Application Data
(60) Provisional application No. 61/025,818, filed on Feb. 4, 2008.

(51) Int. Cl. G11B 7/00

(52) U.S. Cl. 369/44.35; G9B/7

(57) ABSTRACT

A signal processing apparatus for an optical disc with a first type region and a second type region includes a processing module and a determining unit. The processing module is used for transforming an input signal to generate a first output signal according to a first amplifying gain, or to amplify the input signal to generate a second output signal according to a second amplifying gain, wherein the input signal is derived from an optical pickup head. The determining unit is coupled to the processing module and arranged to control the processing module to output the first output signal when the input signal is derived from the first type region. Also, the determining unit outputs the second output signal when the input signal is derived from the second type region.

### CROSS REFERENCE

This application claims the priority of U.S. Provisional Application No. 61/025,818, filed at Feb. 4, 2008, which is included herein by reference.

### BACKGROUND OF THE INVENTION

1. Field of the Invention

The present invention relates to a signal processing apparatus for an optical disc and method thereof.

2. Description of the Related Art

FIG. 1 is a block diagram illustrating a related art TE (tracking error) signal control loop 100 in an optical disc driver. As shown in FIG. 1, the TE signal control loop 100 includes a pre-amplifier 101, a servo adjusting module 103, a TE (tracking error) amplitude detector 105, and a controller 107. A TE signal TES from the optical pickup head 109 is transmitted to the TE signal control loop 100. The pre amplifier 101 is used for amplifying or reducing the amplitude of the TE signal TES such that the TE signal TES will not be over the processing range of following devices, for example, an ADC (not illustrated in FIG. 1). The servo adjusting module 103 is used for adjusting the amplitude of the TE signal TES after the TE signal TES is processed by the pre-amplifier 101, such that the amplitude of the TE signal can match the requirements of the following devices. Also, the TE amplitude detector 105 is utilized for detecting the amplitude of the TE signal. As known by persons skilled in the art, gains of the pre-amplifier 101 and servo adjusting module 103 are determined according to the amplitude of the TE signal TES, which is detected by the TE amplitude detector 105. Such a mechanism has some disadvantages, however, as described below.

As known by persons skilled in the art, a TE signal is generated via detecting and calculating reflection of different photo sensors on the optical pickup head 109. An optical disc includes a data region and a blank region, and the laser from the optical pickup head 109 is somewhat absorbed by the data pit when the laser is located at the data region. Therefore, the reflection of the laser is smaller than that on the blank region, thus the TE signal amplitude on the data region is smaller than the blank region, as shown in FIG. 2.

Accordingly, if the laser is reflected from a region that is a mix of data regions and blank regions, it is hard to distinguish that the TE signal is reflected from which region. Thus, an apparatus or method is needed to solve the problem.

### SUMMARY OF THE INVENTION

Therefore, one objective of the present invention is to provide a signal processing apparatus where the amplitude of the TE signal can be correctly calculated or detected.

One embodiment of the present invention discloses a signal processing apparatus for an optical disc with a first type region and a second type region. The signal processing apparatus includes a processing module and a determining unit. The processing module is used for transforming an input signal to generate a first output signal according to a first amplifying gain, or to amplify the input signal to generate a second output signal according to a second amplifying gain, wherein the input signal is derived from an optical pickup head. The determining unit is coupled to the processing module and arranged to control the processing module to output the first output signal when the input signal is derived from the first type region. Also, the determining unit outputs the second output signal when the input signal is derived from the second type region.

Another embodiment of the present invention discloses a signal processing apparatus for an optical disc with a first type region and a second type region. The signal processing apparatus comprises a determining unit and a detecting module. The determining unit is used for determining that a signal to be detected is derived from the first type region or the second type region. The detecting module comprises: a first loop, for detecting amplitude of the signal to be detected when the determining unit determines that the signal to be detected is derived from the first type region; and a second loop, for detecting amplitude of the signal to be detected when the determining unit determines that the signal to be detected is derived from the second type region.

Another embodiment of the present invention discloses a signal processing apparatus for an optical disc with a first type region and a second type region. The signal processing apparatus comprises a determining unit, a peak-bottom detector, and a control circuit. The determining unit is arranged to determine that an input signal is a first type input signal derived from the first type region or a second type input signal derived from the second type region. The peak-bottom detector is arranged to detect a peak-bottom value of the input signal. The control circuit is arranged to determine that a peak-bottom value of the peak-bottom detector is derived from the first type input signal or the second type input signal according to a determining result from the determining unit.

Corresponding signal processing methods can be obtained according to above-mentioned embodiments, thus are omitted for brevity.

According to the above-mentioned embodiments, the amplitude of the TE signal can be correctly calculated or detected. Therefore the problems of the related art can be avoided and the gains of the pre amplifier and the servo adjusting module can be properly computed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a related art TE signal control loop in an optical disc driver.

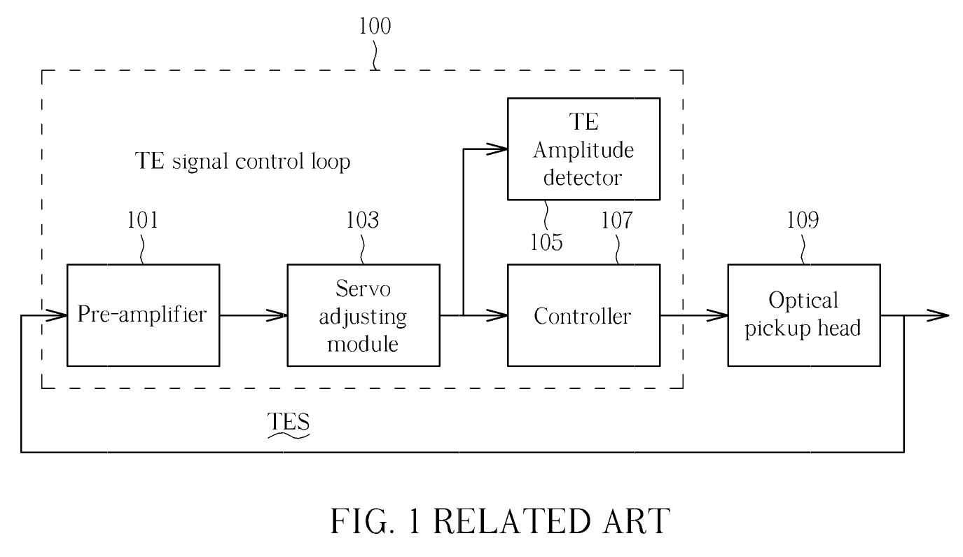

FIG. 2 is a schematic diagram illustrating the phenomenon of TE signals having different amplitudes in a data region and a blank region.

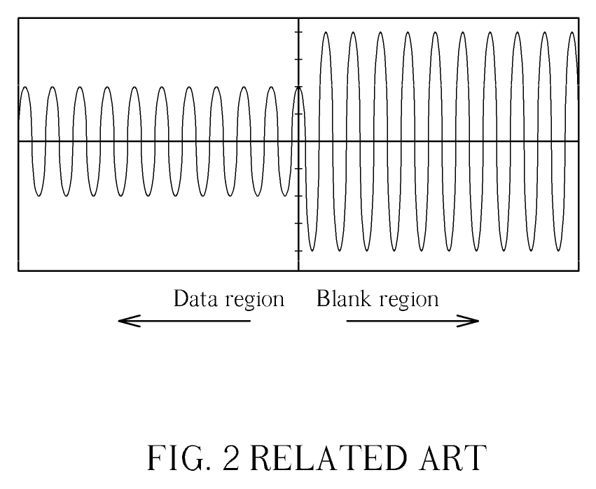

FIG. 3 is a block diagram illustrating a signal processing apparatus according to a first embodiment of the present invention.

FIG. 4 is a schematic diagram illustrating the operation for normalizing amplitude of TE signals for data region and blank region.

FIG. 5 is a flow chart illustrating steps of a signal processing method corresponding to the embodiment shown in FIG. 3.

FIG. 6 is a block diagram illustrating a signal processing apparatus according to a second embodiment of the present invention.

FIG. 7 is a flow chart illustrating steps of a signal processing method corresponding to the embodiment shown in FIG. 6.

FIG. 8 is a block diagram illustrating a signal processing apparatus according to a third embodiment of the present invention.

FIG. 9 is a flow chart illustrating steps of a signal processing method corresponding to the embodiment shown in FIG. 8.

FIG. 10 is a block diagram illustrating a signal processing apparatus according to a fourth embodiment of the present invention.

FIG. 11 is a flow chart illustrating steps of a signal processing method corresponding to the embodiment shown in FIG. 10.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

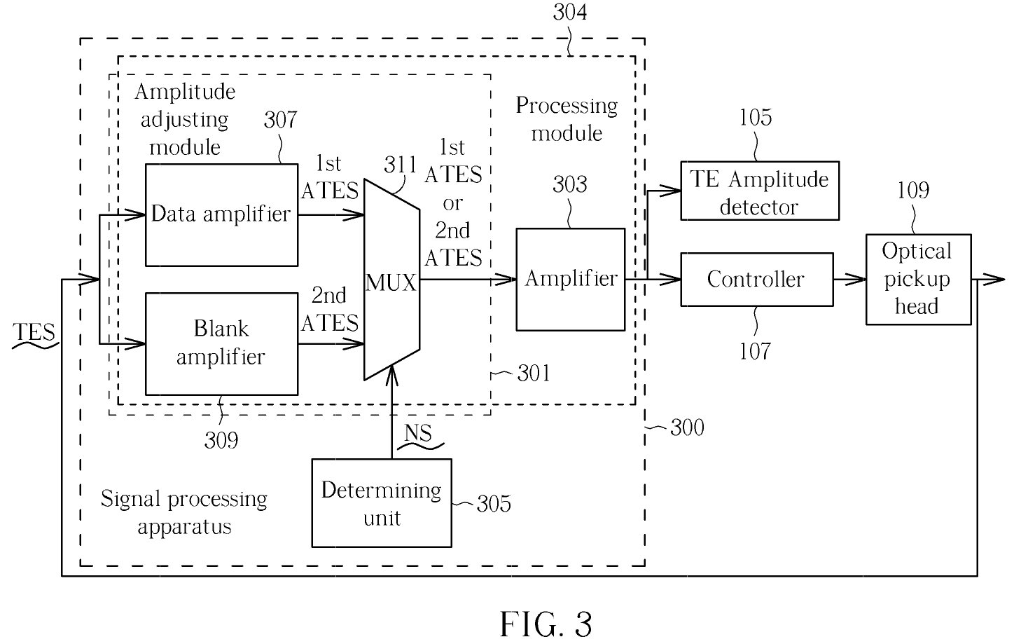

FIG. 3 is a block diagram illustrating a signal processing apparatus 300 according to a first embodiment of the present invention. As shown in FIG. 3, the signal processing apparatus 300 includes an amplitude adjusting module 301, an amplifier 303, and a determining unit 305. Please note that the amplitude adjusting module 301 and the amplifier 303 can be regarded as a processing module 304. The amplitude adjusting module 301 is arranged to amplify a TE signal TES (i.e. an input signal) from the optical pickup head 109 to generate a first amplified TE signal “1^{st} ATES” according to a data amplifying gain. The amplitude adjusting module 301 is also arranged to amplify the TE signal TES to generate a second amplified TE signal “2^{nd} ATES” according to a blank amplifying gain. Since the 1^{st} and 2^{nd} ATES respectively correspond to the data region and the blank region, and the reflection of the data region is smaller than that of the blank region, the data amplifying gain is larger than the blank amplifying gain in this embodiment.

The amplifier 303 is for adjusting amplitude of one of the first amplified TE signal 1^{st} ATES and the second amplified TE signal 2^{nd} ATES. The determining unit 305 is arranged to determine that the TE signal TES is derived from the data region or the blank region (for example, the TE signal TES derived from the blank region can be determined according to a blank flag, or according to a TE signal TES with relatively large amplitude through a duration long enough), and thereby sends a notice signal NS to inform the amplitude adjusting module 301. The amplitude adjusting module 301 outputs the first amplified TE signal 1^{st} ATES when the determining unit 305 determines that the TE signal TES is derived from the data region, and outputs the second amplified TE signal 2^{nd} ATES when the determining unit 305 determines that the TE signal TES is derived from the blank region. It is noted that the data region has a smaller reflectivity than that of the blank region, and the data amplifying gain is larger than the blank amplifying gain.

A smaller gain can be selected by the amplitude adjusting module 301 to avoid the TE signal TES at the blank region being saturated. The TE signal TES may have a larger offset at the blank region than at the data region, and a smaller gain is advantageous for reducing offset of the TE signal at the blank region. Therefore, via selecting a proper gain to amplify the TE signal TES, the TE signal TES can be more stable and the TE amplitude detector can detect the amplitude of the TE signal TES more accurately.

In this embodiment, the amplitude adjusting module 301 includes a data amplifier 307, a blank amplifier 309, and a multiplexer 311. The data amplifier 307 is arranged to amplify the TE signal TES to generate the first amplified TE signal 1^{st} ATES according to the data amplifying gain. The blank amplifier 309 is arranged to amplify the TE signal TES to generate the second amplified TE signal 2^{nd} ATES according to the blank amplifying gain. The multiplexer 311 is arranged to output one of the first amplified TE signal 1^{st} ATES and the second amplified TE signal 2^{nd} ATES according to a determining result from the determining unit 305. Please note that the data amplifier 307 can be a data region amplifier or a data servo amplifier, and the blank amplifier 309 can be a blank servo amplifier or a blank region amplifier. In this case, the data amplifier 307 is a data region amplifier, the blank amplifier 309 is a blank region amplifier, and the amplifier 303 is a servo gain amplifier.

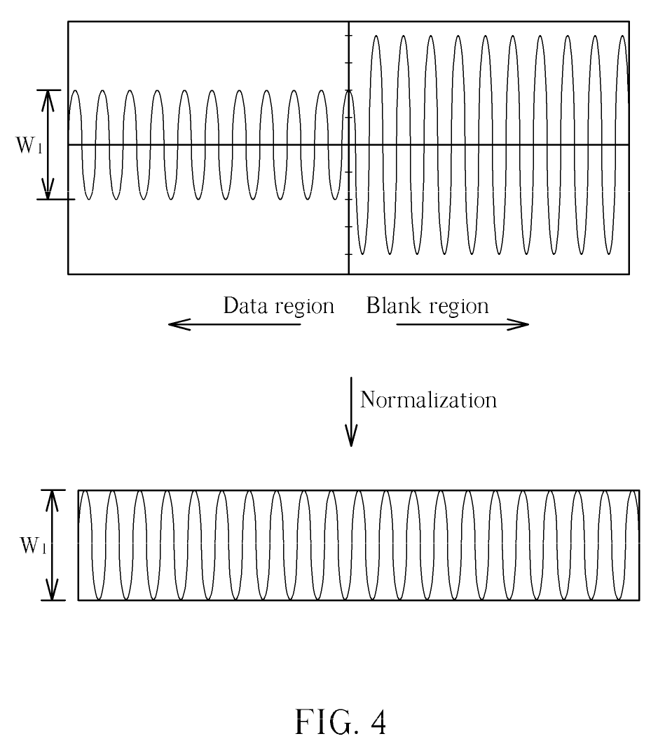

Further extension can be obtained based on the embodiment shown in FIG. 3. For example, the data amplifying gain for the data region and blank amplifying gain for the blank region can be designed to make amplitudes of the TE signals TES at the data region and the blank region equal (i.e. normalize operation to avoid the TE signal TES at the blank region being saturated), as shown in FIG. 4. Additionally, a value of one of the data amplifying gain and blank amplifying gain is determined by a normalization ratio (i.e. a ratio between the data amplifying gain and blank amplifying gain, such that the amplitude of the TE signals TES belonging to data region and the blank region can be normalized) of the data amplifying gain and blank amplifying gain. For example, the blank amplifying gain can be designed to be 75% of the data amplifying gain, thus once the data amplifying gain is determined, the blank amplifying gain can also be obtained. In this case, the normalization ratio 0.75 is a predetermined value but is not meant to limit the scope of the present invention. Therefore, the TE signal TES at the blank region is adjusted to be the same amplitude as that of the TE signal TES at the data region. The amplitude of the TE signal TES at a transition area between the data region and the blank region can be detected as the amplitude at a pure data area (W1 at FIG. 4, for example). Then, the proper data amplifying gain can be calculated, and the blank amplifying gain can be calculated according to the normalization ratio between the blank amplifying gain and the data amplifying gain. In this way, accurate TE signal amplitudes belonging to the data region and the blank region can be obtained.

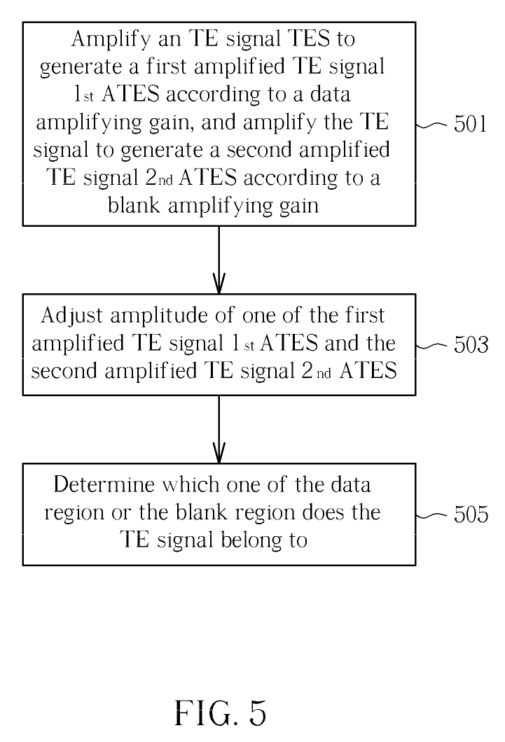

According to the embodiment shown in FIG. 3, a corresponding signal processing method can be obtained, as shown in FIG. 5. The signal processing method includes the steps of:

Step 501:

Amplify (utilizing the amplitude adjusting module 301, for example) a TE signal TES to generate a first amplified TE signal 1^{st} ATES according to a data amplifying gain, or amplify the TE signal TES to generate a second amplified TE signal 2^{nd} ATES according to a blank amplifying gain;

Step 503

Adjust amplitude of one of the first amplified TE signal 1^{st} ATES and the second amplified TE signal 2^{nd} ATES (utilizing the amplifier 303, for exam pie);

Step 505

Determine that the TE signal TES is derived from which one of the data region or the blank region.

The first amplified TE signal 1^{st} ATES is outputted when the step 505 determines that the TE signal TES derived from the data region, and the second amplified TE signal 2^{nd} ATES is outputted when the step 505 determines that the TE signal TES derived from the blank region. Moreover, the normalize operation is executed after the step 505, and it is already described above, thus it is omitted here. It is noted that if reception or detection of one of the data TE amplitude and the blank TE amplitude is fail, the undetected TE amplitude can be extracted from the detected TE amplitude by a normalization ratio.

Other detailed characteristics of the signal processing method shown in FIG. 5 are already shown in FIGS. 3 and 4, and thus are omitted here for brevity.

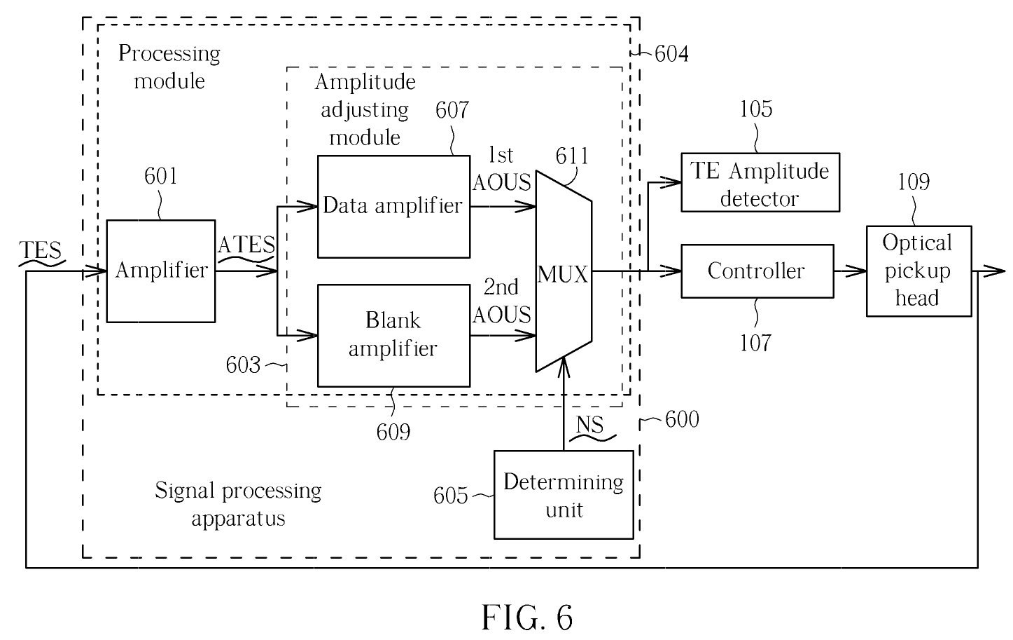

FIG. 6 is a block diagram illustrating a signal processing apparatus 600 according to a second embodiment of the present invention. As shown in FIG. 6, the signal processing apparatus 600 includes an amplifier 601, an amplitude adjusting module 603, and a determining unit 605. The amplifier 601 is arranged to amplify a TE signal TES generated from an optical pickup head 109 to generate an amplified TE signal ATES. The amplitude adjusting module 603 is arranged to adjust amplitude of the amplified TE signal ATES to generate a first output signal 1^{st} OUS according to a data servo amplifying gain, and for adjusting amplitude of the amplified TE signal TES to generate a second output signal 2^{nd} OUS according to a blank servo amplifying gain.

In this embodiment, the data servo amplifying gain is larger than the blank servo amplifying gain, thus the first output signal 1^{st} OUS and the second output signal 2^{nd} OUS are adjusted to approximately have identical amplitude. The determining unit 605 has a similar function as that of the determining unit 305 shown in FIG. 3. The amplitude adjusting module 603 outputs the first output signal 1^{st} OUS when the determining unit 605 determines that the TE signal TES is derived from the data region, and outputs the second output signal 2^{nd} OUS when the determining unit 605 determines that the TE signal TES is derived from the blank region.

The amplifier 601 for amplifying the TE signal TES only includes single gain value, but the amplitude adjusting module 603 includes more than one gain value. Also, one value of the data servo amplifying gain and blank servo amplifying gain is determined by a normalization ratio of the data servo amplifying gain and blank servo amplifying gain, as in the embodiments shown in FIGS. 3 and 4. Please note that the amplitude adjusting module 603 and the amplifier 601 can also be regarded as a processing module 604.

In this case, the amplitude adjusting module 603 includes a data amplifier 607, a blank amplifier 609 and a multiplexer 611. The data amplifier 607 is for adjusting amplitude of the amplified TE signal ATES to generate the first output signal 1^{st} OUS according to the data servo amplifying gain. The blank amplifier 609 is for adjusting amplitude of the amplified TE signal ATES to generate the second output signal 2^{nd} OUS according to the blank servo amplifying gain. The multiplexer 611 is for outputting one of the first output signal 1^{st} OUS and the second output signal 2^{nd} OUS according to a determining result (i.e. the notice signal NS) from the determining unit 605. As above-mentioned description, the data amplifier 607 can be a data region amplifier or a data servo amplifier, and the blank amplifier 609 can be a blank servo amplifier or a blank region amplifier. In this case, the data amplifier 607 is a data servo amplifier, the blank amplifier 309 is a blank servo amplifier, and the amplifier 601 is a pre-amplifier.

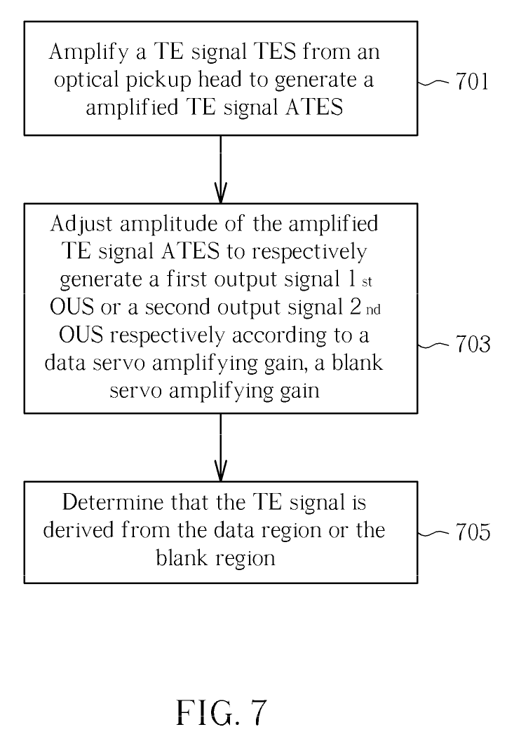

Similarly, according to the second embodiment shown in FIG. 6, a signal processing method corresponding to the second embodiment can be obtained. The signal processing method shown in FIG. 7 includes:

Step 701:

Amplify a TE signal TES from an optical pickup unit to generate a amplified TE signal ATES;

Step 703

Adjust amplitude of the amplified TE signal ATES to generate a first output signal 1^{st} OUS according to data servo amplifying gain, or adjust amplitude of the amplified TE signal ATES to generate a second output signal 2^{nd} OUS according to a blank servo amplifying gain;

The data servo amplifying gain is different from the blank servo amplifying gain, thus the first output signal 1^{st} OUS and the second output signal 2^{nd} OUS are adjusted to approximately have identical amplitude. In this case, the amplitude of the second output signal 2^{nd} OUS is adjusted to be the same as that of the first output signal 1^{st} OUS.

Step 705

Determine that the TE signal TES is derived from the data region or the blank region;

The step 703 outputs the first output signal 1^{st} OUS when the step 705 determines that the TE signal TES is derived from the data region, and outputs the second output signal 2^{nd} OUS when the step 705 determines that the TE signal TES is derived from the blank region.

Other detailed characteristics of the signal processing method shown in FIG. 7 are already shown in FIG. 5, and thus are omitted here for brevity.

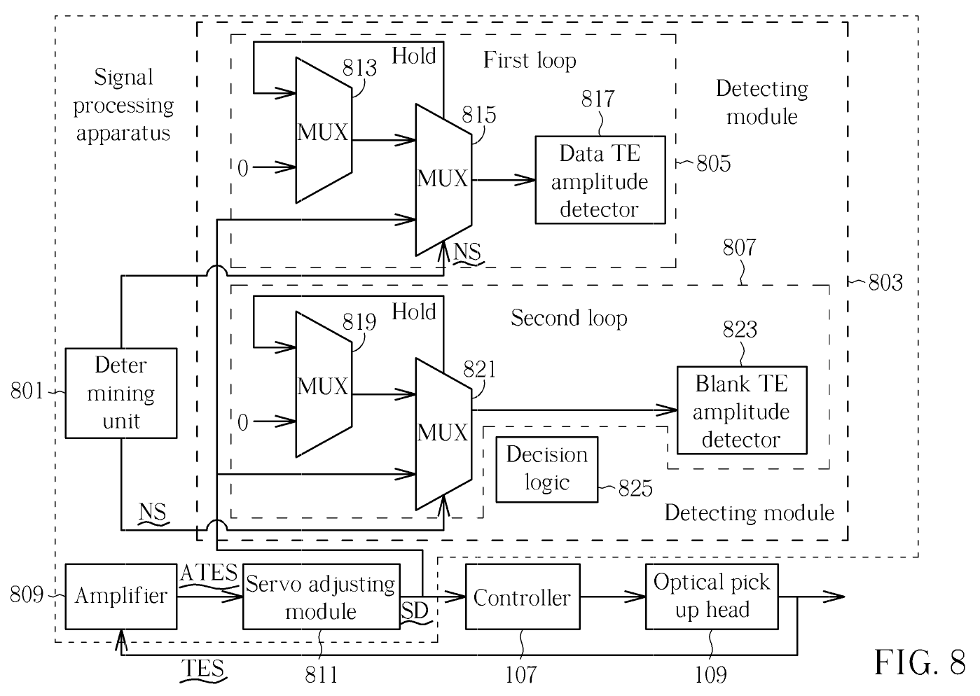

FIG. 8 is a block diagram illustrating a signal processing apparatus 800 according to a third embodiment of the present invention. As shown in FIG. 8, the signal processing apparatus 800 includes a determining unit 801 and a detecting module 803. As mentioned above, the determining unit 801 is arranged to determine that the TE signal TES is derived from the data region or the blank region (i.e. the TE signal TES after processed by the amplifier 809 and the servo adjusting module 811 becomes a signal SD in this embodiment, and the determining unit 801 is arranged to control the signal SD for outputting). The detecting module 803 includes a first loop 805 and a second loop 807. The first loop 805 is arranged to detect an amplitude of the signal to be detected when the determining unit 801 determines that the signal SD to be detected belongs to the data region. The second loop 807 is arranged to detect an amplitude of the signal to be detected when the determining unit 801 determines that the signal belongs to the blank region.

In this embodiment, the signal processing apparatus 800 further includes an amplifier 809 and a servo adjusting module 811. The amplifier 809 is arranged to amplify a TE signal TES from the optical pickup head 109 to generate the amplified TE signal ATES. The servo adjusting module 811 is arranged to adjust an amplitude of the amplified TE signal ATES to generate the signal SD for detecting, which is inputted to the detecting module 803. This is not meant to limit the scope of the present invention. For example, the detecting module 803 can be provided to detect other signals; similarly, the signal SD for detecting is not limited to be derived from the TE signal TES processed by the amplifier 809 and the servo adjusting module 811.

In this embodiment, the first loop 805 includes multiplexers (i.e. a selector) 813 and 815, and a data TE amplitude detector 817. Also, the second loop 807 includes multiplexers 819 and 821, and a blank TE amplitude detector 823. Since the first loop 805 and the second loop 807 have similar operations, the operation of the first loop 805 is illustrated for example. The multiplexer 815 is for outputting a current value of the signal SD or a selector output from the multiplexer 813 according to the notice signal NS. The multiplexer 813 is arranged to select a previous value HOLD of the signal SD to be detected or a predetermined value (0 in this embodiment) as the selector output according to the notice signal NS.

The detecting module 803 further comprises a decision logic 825 for computing a length of the TE signal TES, and for determining whether the signal SD is valid or not according to the length, and for identifying validity of an output of one of the first and second loops according to the length of the signal SD. It is noted that the length here means time length or period length of the signal, and the length can be used to represent the track length or data length on the disc.

For example, if the determining unit 801 determines that a part of the TE signal TES belongs to the blank region and the signal SD is transmitted to the detecting module 803 but the decision logic 825 determines that the length of part of the TE signal TES, which is determined to derived from the blank region, is too short, the TE signal TES is determined to be invalid and the output of the second loop 807 is also determined invalid. It should be noted that the decision logic 825 is not limited to be included in the detecting module 803, and can be configured in other locations, such as merged to the controller 107. Furthermore, the first loop 805 and the second loop 807 can jointly utilize a TE amplitude detector instead of utilizing independent TE amplitude detectors.

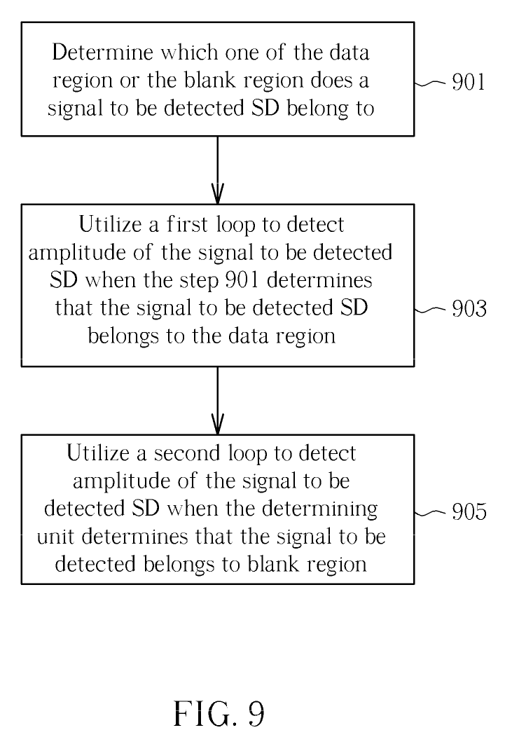

FIG. 9 is a flow chart illustrating steps of a signal processing method corresponding to the embodiment shown in FIG. 8. The method includes:

Step 901

Determine that a signal SD for detecting is derived from the data region or the blank region;

Step 903

Utilize a first loop to detect amplitude of the signal SD when the step 901 determines that the signal SD is derived from the data region;

Step 905

Utilize a second loop to detect amplitude of the signal SD when the step 901 determines that the signal SD is derived from the blank region.

Other detailed characteristics of the signal processing method shown in FIG. 9 are already shown in FIG. 8, and thus are omitted here for brevity.

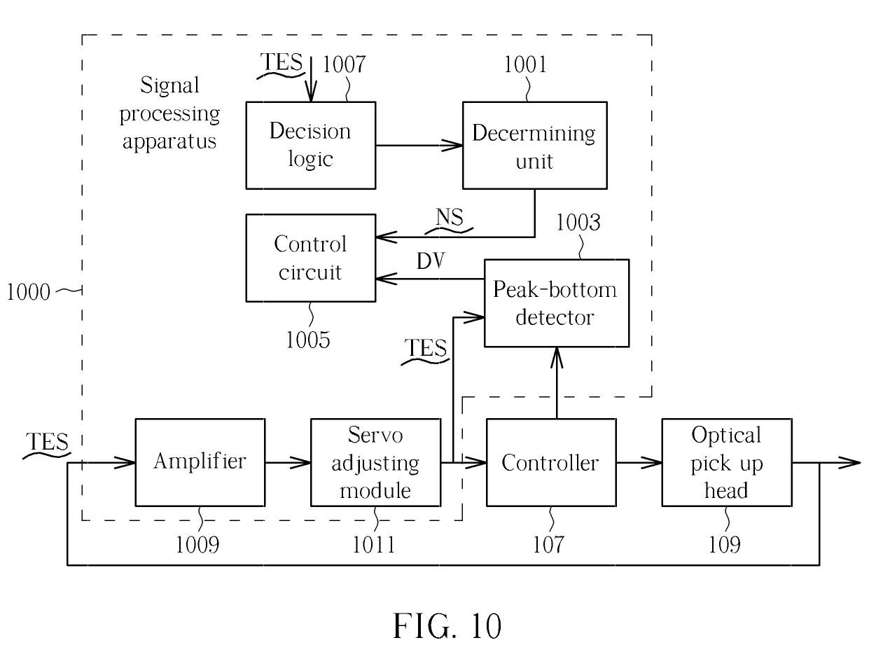

FIG. 10 is a block diagram illustrating a signal processing apparatus 1000 according to a fourth embodiment of the present invention. As shown in FIG. 10, the signal processing apparatus 1000 includes a determining unit 1001, a peak-bottom detector 1003 and a control circuit 1005. The determining unit 1001 is used for determining the TE signal TES belongs to the data region or the blank region. The peak-bottom detector 1003 is arranged to detect a peak-bottom value DV of the TE signal TES, wherein the peak-bottom value DV is arranged to indicate that the TE signal TES is saturated or not. The control circuit 1005 is used for determining that the TE signal TES is derived from the data region according to the notice signal NS from the determining unit 1001. Moreover, when the peak-bottom value DV from the peak-bottom detector 1003 indicates that the TE signal TES is saturated, the control circuit 1005 determines that the TE signal TES needs to be normalized (not shown).

The control circuit 1005 is not limited to be configured in the signal processing apparatus 1000. For example, the control circuit 1005 can be merged to the peak bottom detector 1003.

Moreover, the peak bottom detector 1003 continues detecting the peak bottom value of the TE signal TES to generate the peak-bottom value DV. If the determining unit 1001 determines that the TE signal TES is derived from the data region, the control circuit 1005 regards the peak-bottom value DV as the amplitude of the TE signal TES derived from data regions. Otherwise, if the determining unit 1001 determines that the TE signal TES is derived from the blank region, the control circuit 1005 regards the peak-bottom value DV as the amplitude of the TE signal derived from blank regions.

It is noted that when the notice signal NS from the determining unit 1001 is valid, the associated peak-bottom value DV is identified as that derived from the blank regions. Otherwise, the associated peak-bottom value DV is identified as that derived from the data regions when the notice signal NS is invalid.

The signal processing apparatus 1000 can further include a decision logic 1007 for computing a length of the TE signal TES, and for determining if the TE signal TES is valid or not according to the length of the TE signal TES, and thereby identify validity of the peak-bottom value DV. That is, even though the determining unit 1001 determines that the TE signal is derived from the blank region. If the decision logic 1007 determines that the length of the TE signal TES derived from the blank region is too short, the control circuit 1005 will judge that the peak-bottom value DV is invalid. The decision logic 1007 is not limited to be configured in the signal processing 1000, and can be merged to any other devices.

In this embodiment, the signal processing apparatus 1000 further includes an amplifier 1009 and a servo adjusting module 1011. As described above, the amplifier 1009 is used for amplifying a TE signal TES to generate an amplified TE signal, and the servo adjusting module 1011 is used for adjusting the amplitude of the amplified TE signal. In this embodiment, however, the gains of the amplifier 1009 and the servo adjusting module 1011 are set to be 1, thus the output of the servo adjusting module 1011 is equal to the TE signal TES.

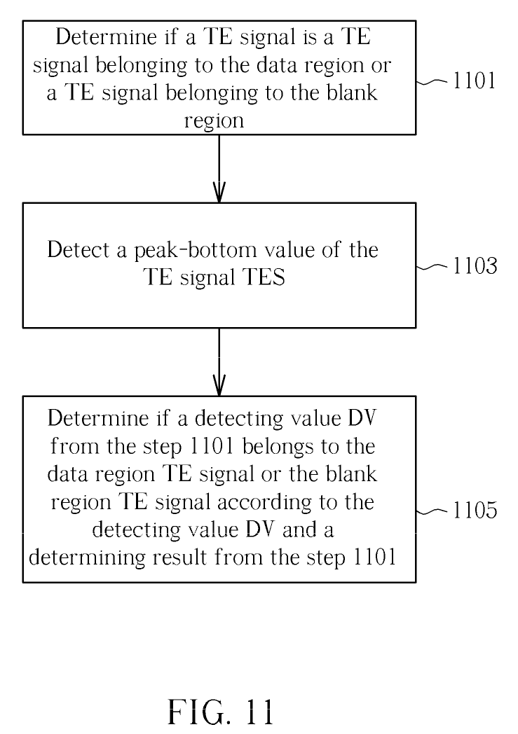

FIG. 11 is a flow chart illustrating steps of a signal processing method corresponding to the embodiment shown in FIG. 10. The steps shown in FIG. 11 include:

Step 1101

Determine that a TE signal is derived from the data region or the blank region;

Step 1103

Detect a peak-bottom value of the TE signal TES;

Step 1105

Determine that the peak-bottom value DV associated with the TE signal is derived from the data region or the blank region according to the peak-bottom value DV and a determining result (i.e. notice signal NS) from the step 1101.

Other detailed characteristics are already shown in the description of FIG. 10, and thus are omitted here for brevity.

It should be noted that the above-mentioned embodiments are not only limited to a data region and a blank region, and can also be applied to different regions of an optical disc. For example, the amplitude adjusting module 301 shown in FIG. 3 is arranged to amplify an input signal from the optical pickup head 109 to generate a first amplified input signal according to a first amplifying gain, and for amplifying the input signal to generate a second amplified input signal according to a second amplifying gain, wherein the first amplifying gain is different from the second amplifying gain. The determining unit 305 is used for determining that the input signal is derived from the first type region or the second type region. Such rules can be applied to any other embodiment, and thus are omitted for brevity.

According to the above-mentioned embodiments, the amplitude of the TE signal can be accurately computed such that the problems of the related art can be avoided.

Those skilled in the art will readily observe that numerous modifications and alterations of the device and method may be made while retaining the teachings of the invention.

What is claimed is:

1. A signal processing apparatus for an optical disc with a first type region and a second type region, the signal processing apparatus comprising:
a processing module, for amplifying an input signal to generate a first output signal according to a first amplifying gain, or to amplify the input signal to generate a second output signal according to a second amplifying gain, wherein the input signal is derived from an optical pickup head; and
a determining unit, coupled to the processing module, arranged to control the processing module to output the first output signal when the input signal is derived from the first type region, and output the second output signal when the input signal is derived from the second type region.

2. The signal processing apparatus of claim 1, wherein the processing module includes:
an amplitude adjusting module arranged to amplify the input signal to generate a first amplified input signal according to the first amplifying gain, or to amplify the input signal to generate a second amplified input signal according to the second amplifying gain; and
a amplifier arranged to adjust amplitude of one of the first amplified input signal and the second amplified input signal to respectively generate the first output signal or the second output signal.

3. The signal processing apparatus of claim 1, wherein the amplitude adjusting module comprises:
a first amplifier, for amplifying the input signal to generate the first amplified input signal according to the first amplifying gain;
a second amplifier, for amplifying an input signal to generate the second amplified input signal according to the second amplifying gain; and
a multiplexer, coupled to the first amplifier and the second amplifier, for outputting one of the first amplified input signal and the second amplified input signal according to a determining result from the determining unit.

4. The signal processing apparatus of claim 1, wherein the first type region has a smaller reflectivity than that of the second type region, and the first amplifying gain is larger than the second amplifying gain.

5. The signal processing apparatus of claim 1, wherein amplitudes of the first amplified input signal derived from the first type region and the second amplified input signal derived from the second type region are normalized to be equal by a normalization ratio.

6. The signal processing apparatus of claim 5, wherein the normalization ratio is determined by the first amplifying gain and the second amplifying gain.

7. The signal processing apparatus of claim 1, wherein the processing module includes:
an amplifier, for amplifying the input signal generated from an optical pickup head to generate an amplified input signal;
a amplitude adjusting module, for adjusting amplitude of the amplified input signal to generate the first output signal according to the first amplifying gain, or for adjusting amplitude of the amplified input signal to generate the second output signal according to the second amplifying gain, wherein the first output signal and the second output signal approximately have an identical amplitude;
wherein the amplitude adjusting module outputs the first output signal when the determining unit determines that the input signal is derived from the first type region, and outputs the second output signal when the determining unit determines that the input signal is derived from the second type region.

8. The signal processing apparatus of claim 7, wherein the amplitude adjusting module comprises:
a first amplifier, for adjusting amplitude of the amplified input signal to generate the first output signal according to the first amplifying gain;
a second amplifier, for adjusting amplitude of the amplified input signal to generate the second output signal according to the second amplifying gain; and
a multiplexer, coupled to the first amplifier and the second amplifier, for outputting one of the first output signal and the second output signal according to a determining result from the determining unit.

9. A signal processing apparatus for an optical disc with a first type region and a second type region, the signal processing apparatus comprising:
a determining unit, for determining that a signal to be detected is derived from the first type region or the second type region; and
a detecting module, coupled to the determining unit, comprising:
a first loop, for detecting amplitude of the signal to be detected when the determining unit determines that the signal to be detected is derived from the first type region; and
a second loop, for detecting amplitude of the signal to be detected when the determining unit determines that the signal to be detected is derived from the second type region.

10. The signal processing apparatus of claim 9, further comprising:
an amplifier, for amplifying an input signal generated from an optical pickup head to generate an amplified input signal; and
a servo adjusting module, coupled to the amplifier, for adjusting amplitude of the amplified input signal to generate the signal to be detected.

11. The signal processing apparatus of claim 10, wherein the first type region has a smaller reflectivity than that of the second type region.

12. The signal processing apparatus of claim 9, wherein at least one of the first and the second loop comprises:
a first selector arranged to output a current value of the signal to be detected or a selector output according to a result derived from the determining unit;
a second selector arranged to select a previous value of the signal to be detected or a predetermined value as the selector output according to the result derived from the determining unit; and
an amplitude detector arranged to detect the output of the first selector.

13. The signal processing apparatus of claim 9, wherein the detecting module further comprises a decision logic for computing a length of the input signal, and determining whether the signal to be detected is valid or not according to the length, and for identifying validity of an output of one of the first and second loops according to the length of the signal to be detected.

14. A signal processing apparatus for an optical disc with a first type region and a second type region, the signal processing apparatus comprising:
a determining unit, arranged to determine that an input signal is a first type input signal derived from the first type region or a second type input signal derived from the second type region;
a peak-bottom detector, arranged to detect a peak-bottom value of the input signal; and
a control circuit arranged to determine that the peak-bottom value is derived from the first type input signal or the second type input signal according to a determining result from the determining unit.

15. The signal processing apparatus of claim 14, wherein the first type region has a smaller reflectivity than that of the second type region.

16. The signal processing apparatus of claim 14, further comprising a decision logic for computing a length of the input signal, and determining if the input signal is valid or not according to the length thereof, and identify validity of the peak-bottom value of the peak-bottom detector according to the length.

17. A signal processing method for an optical disc with a first type region and a second type region, the signal processing method comprising:
amplifying an input signal for generating a first output signal according to a first amplifying gain, or amplifying the input signal for generating a second output signal according to a second amplifying gain, wherein the input signal is derived from an optical pickup head; and
outputting the first output signal when the input signal is derived from the first type region; and
outputting the second output signal when the input signal is derived from the second type region.

18. The signal processing method of claim 17, further comprising:
amplifying the input signal to generate a first amplified input signal according to the first amplifying gain, or amplifying the input signal to generate a second amplified input signal according to the second amplifying gain; and
adjusting amplitude of one of the first amplified input signal and the second amplified input signal to respectively generate the first output signal or the second output signal.

19. The signal processing method of claim 17, wherein the first type region has a smaller reflectivity than that of the second type region, and the first amplifying gain is larger than the second amplifying gain.

20. The signal processing method of claim 17, wherein amplitudes of the first amplified input signal derived from the first type region and the second amplified input signal derived from the second type region are normalized to be equal by a normalization ratio.

21. The signal processing method of claim 20, wherein the normalization ratio is determined by the first amplifying gain and the second amplifying gain.

22. The signal processing method of claim 17, wherein the processing method comprises:
amplifying the input signal generated from an optical pickup head to generate an amplified input signal;
adjusting amplitude of the amplified input signal to generate the first output signal according to the first amplifying gain, or adjusting amplitude of the amplified input signal to generate the second output signal according to the second amplifying gain, wherein the first output signal and the second output signal approximately have an identical amplitude;
outputting the first output signal when the input signal is determined to be derived from the first type region, and outputting the second output signal when the input signal is determined to be derived from the second type region.

23. A signal processing method for an optical disc with a first type region and a second type region, the signal processing method comprising:
(a) determining that a signal to be detected is derived from the first type region or the second type region;
(b) utilizing a first loop to detect amplitude of the signal to be detected when the step (a) determines that the signal to be detected is derived from the first type region; and
(c) utilizing a second loop to detect amplitude of the signal to be detected when the step (a) determines that the signal to be detected is derived from the second type region.

24. The signal processing method of claim 23, further comprising:
amplifying an input signal generated from an optical pickup head to generate an amplified input signal; and
adjusting amplitude of the amplified input signal to generate the signal to be detected.

25. The signal processing method of claim 23, wherein the first type region has a smaller reflectivity than that of the second type region.

26. The signal processing method of claim 23, wherein the step (a) further comprises computing a length of the input signal, determining if the signal to be detected is valid or not according to the length, and identifying validity of an output of one of the first and second loops according to the length.

27. A signal processing method for an optical disc with a data region and a blank region, the signal processing method comprising:
(a) determining whether an input signal is derived from the blank region or not; and
(b) determining that a peak-bottom value of the input signal is associated with the blank region according to a determining result from the step (a).

28. The signal processing method of claim 27, wherein the first type region has a smaller reflectivity than that of the second type region.

29. The signal processing method of claim 27, wherein the step (a) further comprises computing a length of the input signal to determining that the input signal is derived from the blank region.
